(19) United States
(12) Patent Application Publication
(10) Pub. No.: US 2026/0114671 A1
(43) Pub. Date: Apr. 30, 2026

(54) AUTOMATIC FRYER BASKET SUPPLYING DEVICE

(71) Applicant: SINWON MICRON CO., LTD., Busan (KR)

(72) Inventors: Seung Ho LEE, Busan (KR); Choong Ho LEE, Ulsan (KR)

(73) Assignee: SINWON MICRON CO., LTD., Busan (KR)

(21) Appl. No.: 19/374,564

(22) Filed: Oct. 30, 2025

(30) Foreign Application Priority Data
Oct. 30, 2024 (KR) 10-2024-0150355

(51) Int. Cl. A47J 37/12

(52) U.S. Cl. CPC A47J 37/1219; A47J 37/1266

(57) ABSTRACT

An automatic fryer basket supplying device including: a supply unit installed at one side of a frying pot to enable a fryer basket to be loaded into or unloaded from frying oil; and a control unit configured to control an operation of the supply unit. The supply unit includes: a support frame part fastened at one side of the frying pot to be vertical to the ground and configured to be length-adjustable in a vertical direction; and a vertical transfer module fastened to an upper portion of the support frame part and operated under control of the control unit to elevate or lower the fryer basket. A plurality of the supply units are selectively installed according to the capacity of the frying pot, and the plurality of supply units are individually controlled by the control unit.

### CROSS-REFERENCE TO RELATED PATENT APPLICATION

This Application claims priority to Korean Patent Application No. 10-2024-0150355 (filed on October 30, 2024), which is all hereby incorporated by reference in its entirety.

### BACKGROUND

The present invention relates to an automatic fryer basket supplying device, and more specifically, to an automatic fryer basket supplying device that can automatically perform operations in which a fryer basket is loaded into and unloaded from frying oil during a chicken frying process.

In general, a chicken frying process includes a preliminary frying step of loading a fryer basket containing chicken pieces into frying oil and shaking the fryer basket in the frying oil, an unloading step of unloading the fryer basket from the frying oil and waiting for a predetermined period of time, and a refrying step of loading the fryer basket back into the frying oil to refry the chicken pieces. After the refrying is completed, the fryer basket is shaken to remove the frying oil from the fryer basket, thereby completing the cooking process. As described above, the chicken frying process requires multiple manual operations such as loading, unloading, and shaking of the fryer basket, which are necessary for proper cooking. Accordingly, workers are often exposed to high heat and the risk of burns from the frying oil.

As a conventional art document aimed at overcoming such problems in the conventional chicken frying process, Korean Patent No. 10-1288282 discloses a lift-type frying device.

However, such conventional technologies do not provide operations, such as the fryer basket shaking step, the preliminary frying step, and the refrying step, which are essential in the chicken frying process.

Related Art: Korean Patent No. 10-1288282 (July 15, 2013)

### SUMMARY

Accordingly, the present invention has been made to solve the above-mentioned problems occurring in the prior arts, and it is an objective of the present invention to provide an automatic fryer basket supplying device capable of automatically performing preliminary frying and refrying of chicken pieces, and shaking of a fryer basket in the chicken frying process.

To accomplish the above objective, according to the present invention, there is provided an automatic fryer basket supplying device including: a supply unit installed at one side of a frying pot to enable a fryer basket to be loaded into or unloaded from frying oil; and a control unit configured to control an operation of the supply unit, wherein the supply unit includes: a support frame part fastened at one side of the frying pot to be vertical to the ground and configured to be length-adjustable in a vertical direction; and a vertical transfer module fastened to an upper portion of the support frame part and operated under control of the control unit to elevate or lower the fryer basket, and a plurality of the supply units are selectively installed according to the capacity of the frying pot, and the plurality of supply units are individually controlled by the control unit.

The automatic fryer basket supplying device according to an embodiment of the present invention can automatically perform the frying process of elevating the fryer basket and shaking the fryer basket which are essential for frying chicken pieces.

Additionally, the automatic fryer basket supplying device according to an embodiment of the present invention is configured as a unit-type module, and one or more supply units can be selectively installed according to the capacity of the frying pot, and each unit can be individually controlled.

In addition, the automatic fryer basket supplying device according to an embodiment of the present invention provides an effect in that, during the process of shaking the fryer basket to remove oil or performing preliminary frying, the fryer basket is rotatable and shakable not only in the vertical direction but also in the front-rear direction.

### BRIEF DESCRIPTION OF THE DRAWINGS

FIG. 1 is a view illustrating a state in which a plurality of supply units of an automatic fryer basket supplying device according to a first embodiment of the present invention are installed.

FIG. 2 is an exploded perspective view of the supply unit of the automatic fryer basket supplying device according to the first embodiment of the present invention.

FIG. 3 is a view illustrating a state in which a main body frame of the automatic fryer basket supplying device according to the first embodiment of the present invention is fastened to a frying pot.

FIG. 4 is a view showing a state in which the main body frame and a subsidiary body frame of the automatic fryer basket supplying device according to the first embodiment of the present invention are coupled.

FIG. 5 is a view illustrating a state in which a vertical transfer module of the automatic fryer basket supplying device according to the first embodiment of the present invention is moved by a spacer.

FIG. 6 is a view illustrating a hanger part and a fryer basket of the automatic fryer basket supplying device according to the first embodiment of the present invention.

FIG. 7 is a view illustrating a state in which the fryer basket of the automatic fryer basket supplying device according to the first embodiment of the present invention is shaken in both vertical and front-rear directions.

FIG. 8 is a view illustrating a state in which a vertical transfer module of an automatic fryer basket supplying device according to a second embodiment of the present invention is driven.

FIG. 9 is a view illustrating a state in which a vertical transfer module of an automatic fryer basket supplying device according to a third embodiment of the present invention is driven.

FIG. 10 is a view illustrating a state in which a vertical transfer module of an automatic fryer basket supplying device according to a fourth embodiment of the present invention is driven.

### DETAILED DESCRIPTION

Before describing the present invention in detail, brief explanations of the terms used in this specification will be provided.

The terms including descriptive or technical terms which are used herein should be construed as having meanings that are obvious to one of ordinary skill in the art. However, the terms may have different meanings according to an intention of one of ordinary skill in the art, precedent cases, or the appearance of new technologies. Accordingly, the terms used in the present invention should not be interpreted based only on their names but should be defined based on their meanings and the overall content of the present invention.

Throughout the specification, when a part "includes" or "comprises" a component, the part can further include other components, not excluding the other components unless explicitly stated otherwise.

Hereinafter, embodiments of the present invention will be described in detail with reference to the accompanying drawings, so that those skilled in the art can easily carry out the invention. However, the present invention is not limited to the embodiments described herein and may be implemented in various other forms.

Details including the objectives of the present invention, means for achieving the objectives, and effects of the invention are included in the following embodiments and drawings. The advantages and features of the present invention and means for achieving them will be clearly understood from the following detailed description of the embodiments with reference to the accompanying drawings.

Hereinafter, an automatic fryer basket supplying device according to the present invention will be described in detail with reference to the accompanying drawings.

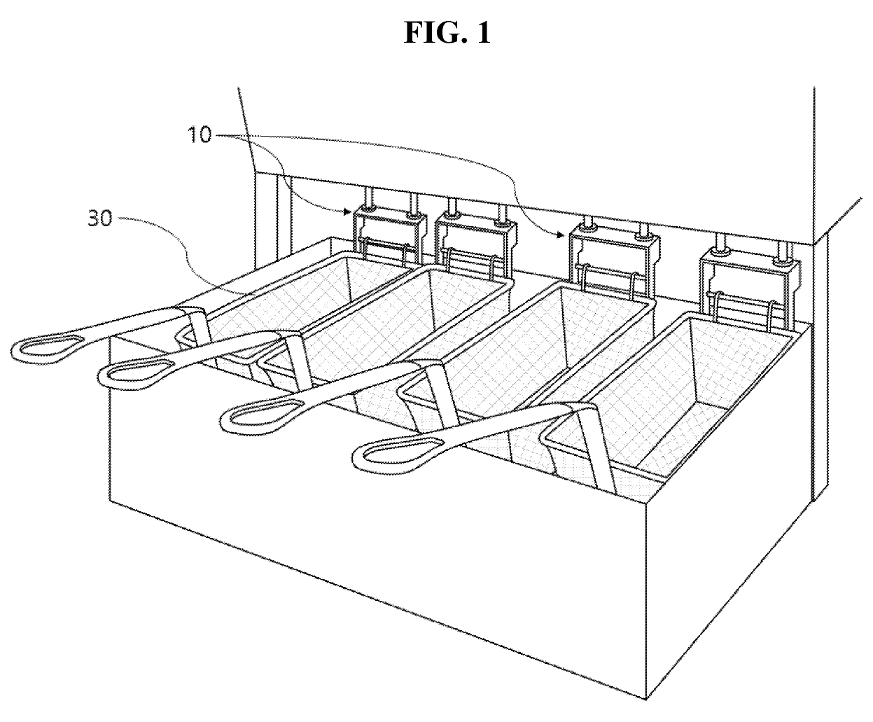

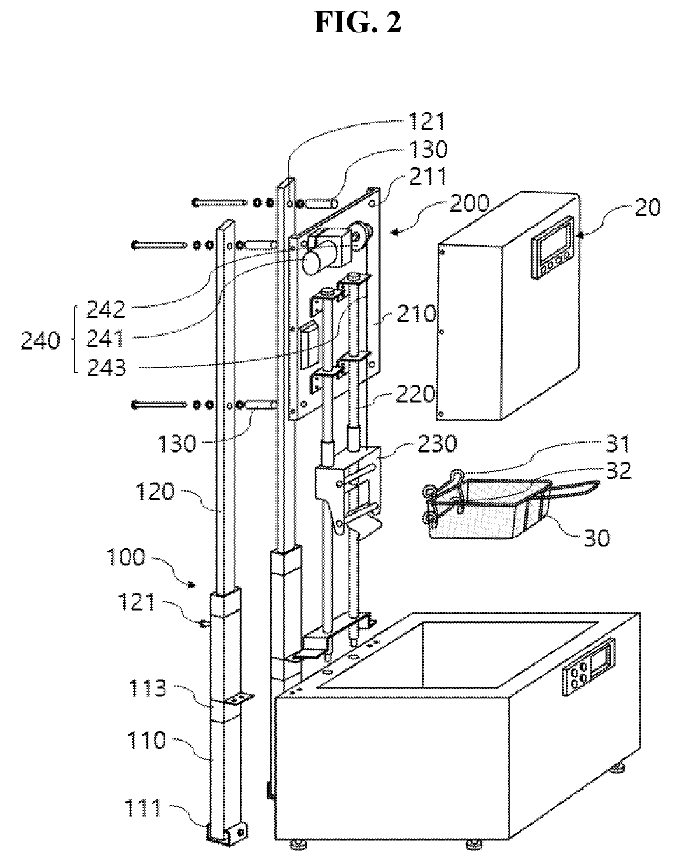

With reference to FIGS. 1 and 2, an automatic fryer basket supplying device according to a first embodiment of the present invention includes: a supply unit 10 installed at one side of a frying pot and configured to load or unload a fryer basket 30 into or from frying oil; and a control unit 20 configured to control the operation of the supply unit 10. Moreover, the supply unit 10 may be selectively provided as a single or plurality of units according to the capacity of the frying pot and is individually controlled by the control unit 20. That is, each supply unit 10 is configured to hold a separate fryer basket 30 and may be provided in a single-unit or multi-unit configuration depending on the capacity and size of the frying pot. Specifically, referring to FIG. 1, four supply units 10 are arranged to correspond to the capacity of the frying pot, and each of the supply units 10 is individually controlled by the control unit 20 to selectively and automatically perform the frying process. In this instance, the fryer basket 30 is provided in the form of a typical cooking tool having a handle on one side thereof and a body formed of a metal mesh. The fryer basket 30 further has a plurality of hooks provided on the other side thereof so that the fryer basket 30 can be caught and secured to the supply unit 10. Accordingly, the supply unit 10 elevates or lowers the fryer basket 30 while the fryer basket 30 is secured, such that the fryer basket 30 is loaded into or unloaded from the frying pot. Additionally, the supply unit 10 repeats short-range vertical movements to shake the fryer basket 30 in the vertical direction.

Furthermore, the control unit 20 controls the supply unit 10 such that the fryer basket 30 is loaded into the frying oil for a first time to perform preliminary frying of food to be fried and shaken vertically, loaded again into the frying oil for a second time to perform refrying of the preliminarily fried food, and then unloaded from the frying oil and shaken again in the vertical direction. In this instance, the control unit 20 operates the supply unit 10 by adjusting parameters such as the time the fryer basket 30 is immersed in the oil, the waiting time of the fryer basket 30 after being taken out, and the frequency and amplitude of the shaking, according to preset values configured in advance by a user.

More specifically, referring to FIG. 2, the supply unit 10 includes: a support frame part 100 that is vertically fastened to one side of the frying pot and is adjustable in length in a vertical direction; and a vertical transfer module 200 that is mounted on an upper portion of the support frame part 100 and operated under the control of the control unit 20 to elevate or lower the fryer basket 30.

The support frame part 100 supports the vertical transfer module 200 fastened thereto and allows positional adjustment of the vertical transfer module 200 so that the vertical transfer module 200 can load the fryer basket 30 precisely into the frying oil in the frying pot. For example, the support frame part 100 includes: a main body frame 110 formed in a hollow square column shape and disposed in close contact with the rear side of the frying pot; a subsidiary body frame 120 inserted and connected into the main body frame 110 and movable in a direction perpendicular to the ground; and a spacer 130 fastened to an upper portion of the subsidiary body frame 120. In this instance, the support frame parts 100 are provided in a pair such that two support members are fastened to each vertical transfer module 200.

Furthermore, the main body frame 110 includes: a body clamping part 111 that extends outward from a lower end of the main body frame 110 and protrudes upward and has an end bent toward the main body frame 110; a body fastening bolt 112 that penetrates the main body frame 110, the body clamping part 111, and a rear portion of the frying pot and is fastened using a bolt and a nut; and a body fastener 113 that is coupled to the outer circumferential surface of the main body frame 110 and is slidable in a longitudinal direction.

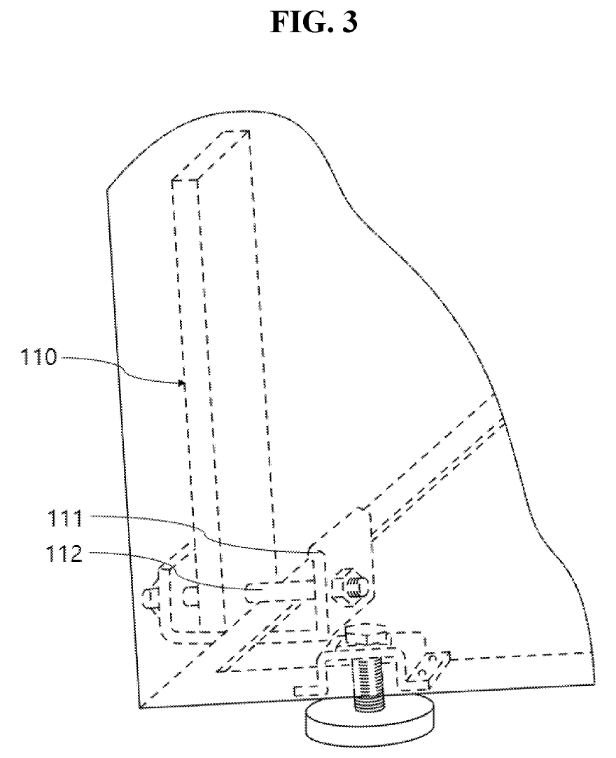

As illustrated in FIG. 3, when the main body frame 110 is disposed in close contact with the rear side of the frying pot, the bent end of the body clamping part 111 comes into contact with an inner wall of a lower portion of the frying pot. The body fastening bolt 112 is inserted through the main body frame 110 and the frying pot, and then fastened to the body clamping part 111 using a bolt and a nut. That is, the lower portions of the frying pot and the main body frame 110 are securely joined together by the body clamping part 111. Additionally, the body fastener 113 slides along the body of the main body frame 110 and is provided with a flange protruding toward the frying pot such that the body fastener can be fastened to the top surface of the frying pot. In other words, the body fastener 113 can be adjusted in position and fastened according to the height of the frying pot.

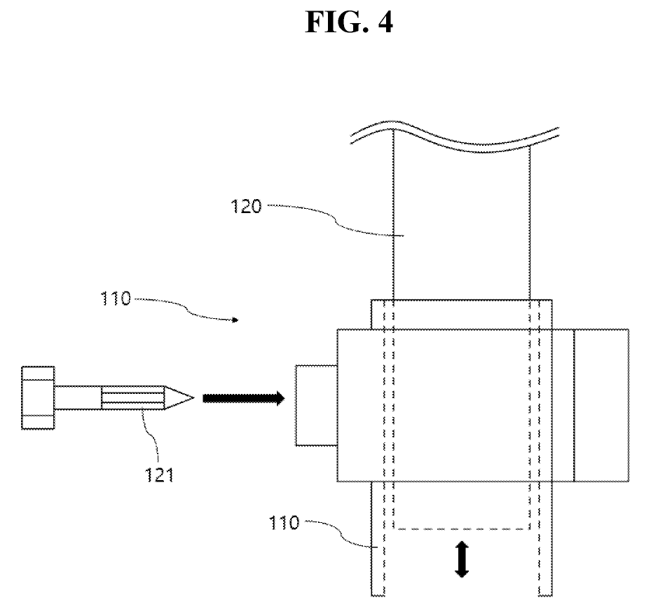

Referring to FIG. 4, the subsidiary body frame 120 is inserted into an upper portion of the main body frame 110 and protrudes upward, serving to adjust the mounting height of the vertical transfer module 200. In addition, the subsidiary body frame 120 includes: a subsidiary body fastening bolt 121 horizontally inserted through a side of the upper portion of the main body frame 110 and allowing the subsidiary body frame 120 to be bolt-fastened; and a plurality of spacer fastening holes 122 formed on a side of the upper surface of the subsidiary body frame 120. The subsidiary body fastening bolt 121 defines the coupling position between the main body frame 110 and the subsidiary body frame 120, thereby adjusting the upward protrusion height of the subsidiary body frame 120. The spacer fastening holes 122 are arranged in plural on the upper portion of the subsidiary body frame 120 and spaced apart vertically to allow the spacer 130 to be fastened. Moreover, the spacer 130 protrudes from a side surface of the subsidiary body frame 120 to be oriented horizontally with respect to the ground, and is formed in the shape of a circular rod. Furthermore, the spacer 130 is inserted into and connected to the vertical transfer module 200, and allows the vertical transfer module 200 to slide horizontally in the longitudinal direction of the spacer 130.

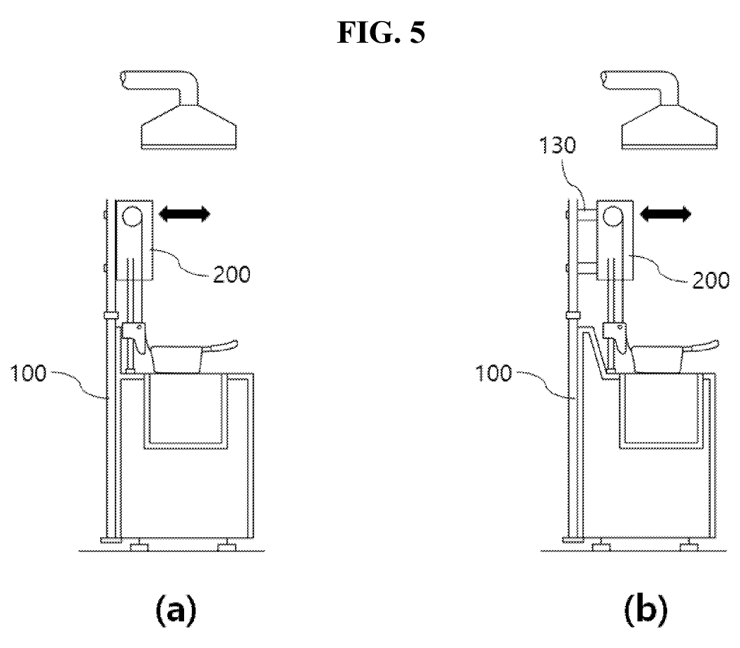

As illustrated in FIG. 5, the vertical transfer module 200 is connected to the spacer 130 to be slidable along the spacer 130 so that the mounting position can be adjusted according to the shape of the frying pot or the location of an overhead hood.

Next, the vertical transfer module 200 includes: a transfer module mounting frame 210 in the form of a flat plate fastened to the upper portion of the support frame part 100; a guide part 220 joined to one surface of the transfer module mounting frame 210 and arranged vertically with respect to the ground; a hanger part 230 connected to the guide part 220 and movable in the vertical direction; and a driving part 240 installed at one side of the transfer module mounting frame 210 to provide driving force for elevating and lowering the hanger part 230.

Moreover, the transfer module mounting frame 210 has a rectangular plate shape, and includes spacer insertion holes 211 formed at the corners of the transfer module mounting frame 210 and corresponding in diameter to the spacers 130 to allow insertion of the spacers 130.

The guide part 220 is provided in the form of a rod, fixed to one side of the transfer module mounting frame 210, and extends downwardly such that a lower end of the guide part 220 can be secured to one side of the frying pot. Additionally, the guide parts 220 are provided in a pair and arranged to vertically penetrate the hanger part 230 and to guide the movement direction of the hanger part 230.

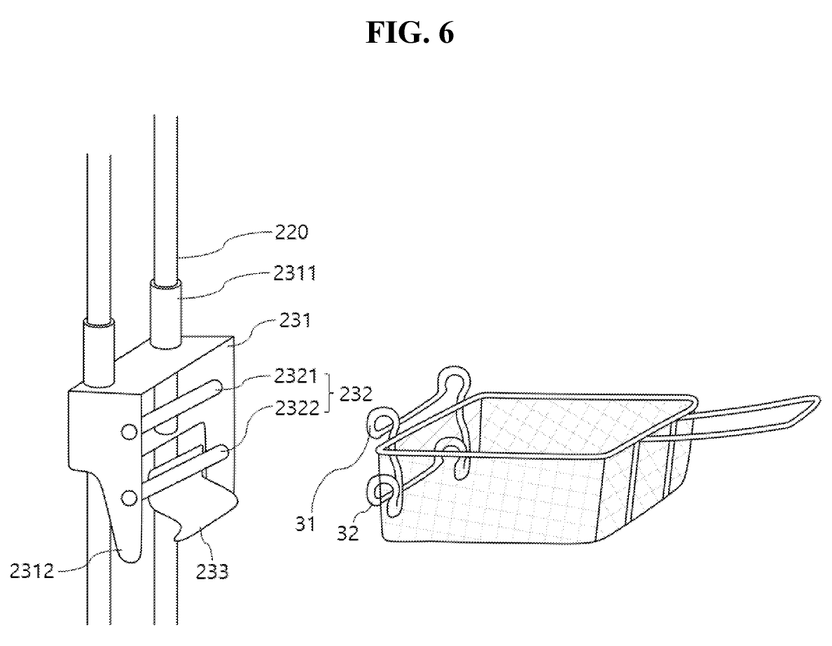

Additionally, referring to FIG. 6, the hanger part 230 includes: a hanger frame 231 formed in a rectangular cuboid shape with an open front; hanger rods 232 respectively fixed to both sides of the inner wall of the hanger frame 231 and having a rod shape to which the fryer basket 30 is hook-fastened; and a plate spring 233 extending downward from the bottom surface of the hanger frame 231 and inclined toward the fryer basket 30 to support one side of the fryer basket 30. Moreover, the hanger frame 231 includes: a tubular member 2311 extending upward from the top of the hanger frame 231 and formed in a cylindrical shape enclosing the outer surface of the guide part 220; and an extension member 2312 extending downward from the bottom of the hanger frame 231. The tubular member 2311 is formed to correspond to the diameter of the guide part 220, thereby preventing any clearance between the hanger part 230 and the guide part 220. That is, the tubular member 2311 ensures that the hanger part 230 can slide stably along the guide part 220. Additionally, the hanger rods 232 include: a first hanger rod 2321 disposed on an upper inner side of the hanger frame 231; and a second hanger rod 2322 spaced below the first hanger rod 2321. In this instance, the second hanger rod 2322 is disposed on an inner lower wall of the extension member 2312. In addition, the fryer basket 30 includes: a first hook portion 31 provided on the top of the fryer basket 30 and hooked to the first hanger rod 2321; and a second hook portion 32 provided below the first hook portion 31, hooked to the second hanger rod 2322, and having a larger radius of curvature than the first hook portion 31. In this instance, the first hook portion 31 is compactly coupled to the first hanger rod 2321. Thus, when the fryer basket 30 is joined to the hanger part 230, the fryer basket 30 is rotatable and shakable around the first hanger rod 2321 within a range where the engagement between the second hook portion 32 and the second hanger rod 2322 is maintained. In other words, because the second hook portion 32 has a larger radius of curvature than the first hook portion 31, a clearance is created around a contact area between the second hook portion 32 and the second hanger rod 2322. Accordingly, the fryer basket 30 is rotatable and shakable around the first hanger rod 2321 by the extent of the clearance.

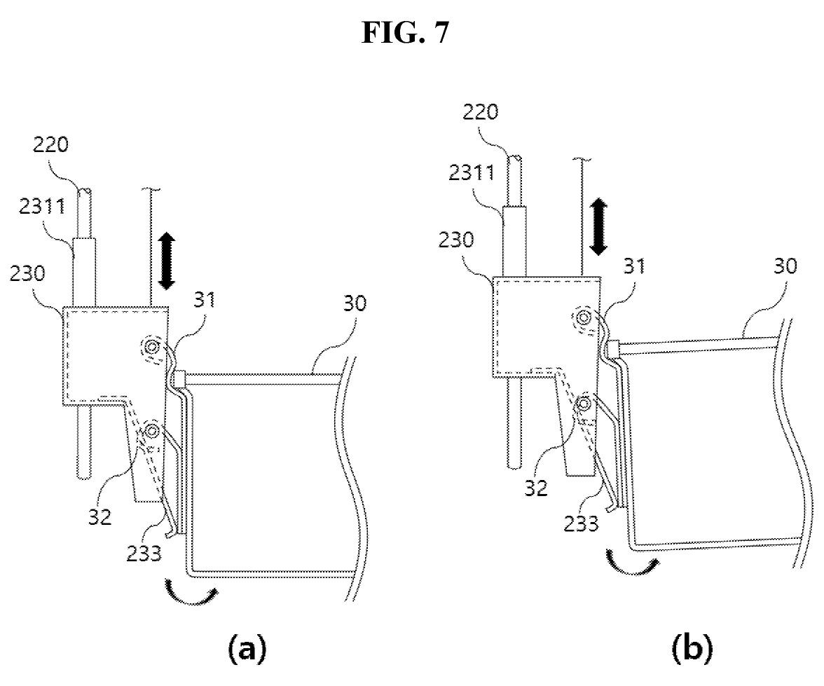

Referring to FIG. 7, the plate spring 233 is formed to elastically deform while supporting a horizontal load of the fryer basket 30. When the hanger part 230 is rapidly reciprocated in the vertical direction by the driving part 240, the fryer basket 30 is subjected to a restoring force from the plate spring 233, and as a result, can be shaken not only in the vertical direction but also in the rotational direction. That is, the plate spring 233 and the clearance created by the second hook portion 32 and the second hanger rod 2322 enable the fryer basket 30 to be shaken in multiple directions, thereby allowing oil to be effectively shaken off. Additionally, because the fryer basket 30 is shaken in multiple directions, the fried food within the frying oil is prevented from sticking together during cooking.

In addition, the driving part 240 includes: a motor 241 mounted on the transfer module mounting frame 210; a winch 242 rotatably connected to an output shaft of the motor 241; and a wire 243 wound around the winch 242 and connected to one side of the hanger part 230. In this instance, the motor 241 is configured to rotate in forward and reverse directions under the control of the controller 20. Furthermore, the winch 242 allows the hanger part 230 connected to the wire 243 to be raised or lowered depending on the rotational direction.

Hereinafter, an automatic fryer basket supplying device according to a second embodiment of the the present invention will be described. In this embodiment, the difference from the first embodiment lies in that a driving part of a supply unit is implemented in the form of a linkage. The description of components overlapping with the first embodiment will be incorporated by reference to the description of the first embodiment.

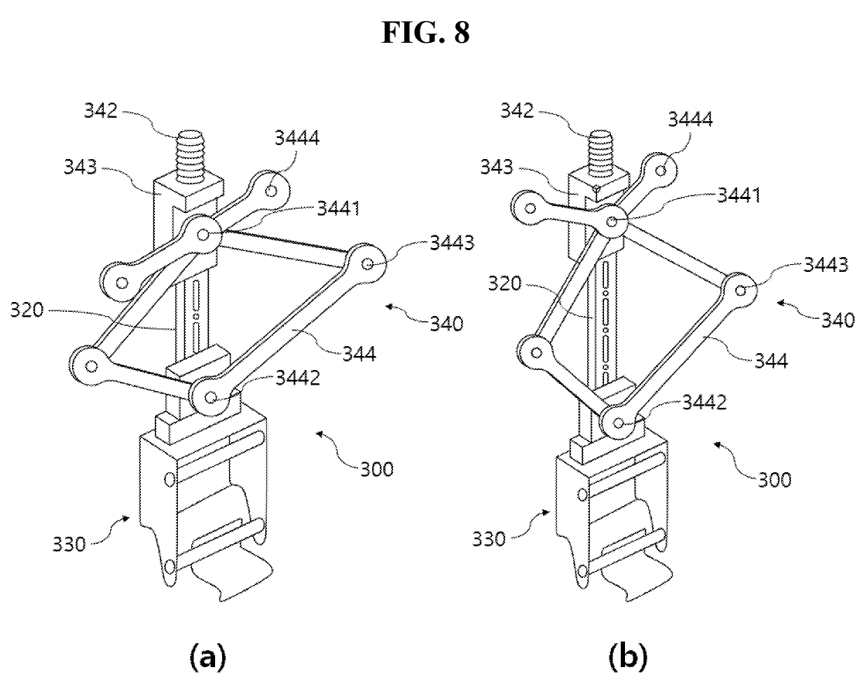

Referring to FIG. 8, a vertical transfer module 300 according to the present invention includes a transfer module mounting frame 310, a guide part 320, a hanger part 330, and a driving part 340. The guide part 320 includes a rail which is provided in a linear form, installed on one side of the transfer module mounting frame 310, arranged vertically with respect to the ground, and formed on one side in the longitudinal direction. Moreover, the driving part 340 is installed at the top of the guide part 320 and includes a screw 342 that is rotated and vertically moved by a nut unit 341 to be guided in lifting direction. The screw 342 is operated by receiving power through a motor (not shown). Additionally, a link transfer part 343 is disposed at an end of the screw 342 and is vertically moved by the rotation of the screw 342. In addition, the link transfer part 343 is connected to the top of the guide part 320 to be movable along the guide part 320. The hanger part 330 is connected to the bottom of the guide part 320 to be movable along the guide part 320. Moreover, a link mechanism 344, which has multiple joints and is expandable and contractible in the vertical direction, is provided between the link transfer part 343 and the hanger part 330. In this instance, the link mechanism 344 includes a first joint 3441 connected to the link transfer part 343, and a second joint 3442 connected to the hanger part 330. Furthermore, the link mechanism 344 is formed in a diamond-shaped loop structure with the first joint 3441 and second joint 3442 as reference points. The link mechanism 344 further includes a pair of third joints 3443 provided at both side corners of the loop to allow the link mechanism 344 to expand and contract. Additionally, the link mechanism 344 also includes an operation link part 3444 that operates in response to the vertical movement of the first joint 3441. The operation link part 3444 is configured to extend upward from the first joint 3441 and is shorter than the length of the links forming the loop of the link mechanism 344. In addition, the operation link part 3444 is installed such that joint axes at both ends are fixed, enabling the link mechanism 344 arranged below the operation link part 3444 to rotate about the fixed joint axes. More specifically, when the link transfer part 343 descends and the first joint 3441 moves downward, the operation link part 3444 rotates downward about the fixed joint axes on both sides and folds inwardly toward the center, causing the third joints 3443 to expand outward. As the third joints 3443 expand, the hanger part 330 connected to the second joint 3442 is lowered accordingly. Conversely, when the link transfer part 343 ascends and the first joint 3441 moves upward, the operation link part 3444 rotates upward about the fixed joint axes and unfolds into a straight form, causing the third joints 3443 to fold inward. Furthermore, as the third joints 3443 contract, the hanger part 330 connected to the second joint 3442 is raised accordingly. That is, the link mechanism 344 enables the hanger part 330 to move a greater distance than the movement range of the link transfer part 343, thereby amplifying the lifting stroke.

Hereinafter, an automatic fryer basket supplying device according to a third embodiment of the the present invention will be described. In this embodiment, the difference from the first embodiment lies in that a driving part of a supply unit is implemented in the form of a rack-pinion gear. The description of components overlapping with the first embodiment will be incorporated by reference to the description of the first embodiment.

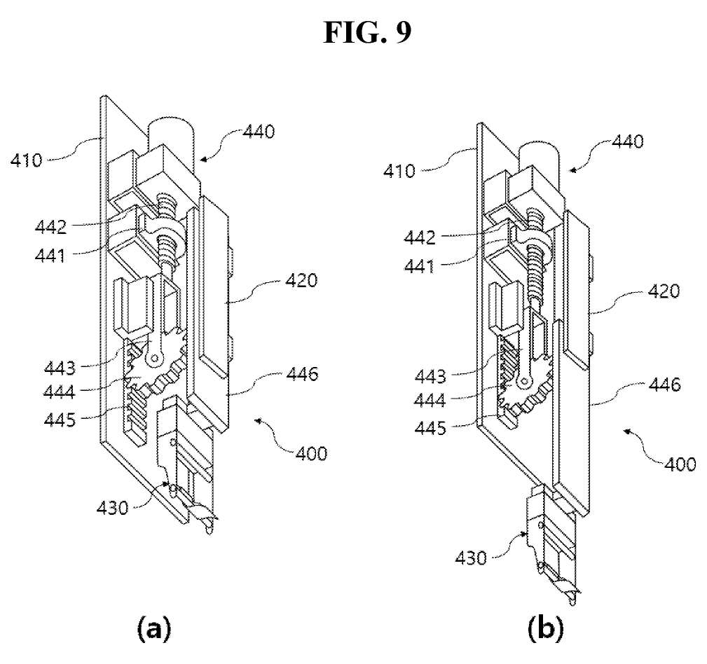

Referring to FIG. 9, a vertical transfer module 400 according to the present invention includes a transfer module mounting frame 410, a guide part 420, a hanger part 430, and a driving part 440. The guide part 420 includes a rail which is provided in a linear form, installed on one side of the transfer module mounting frame 410, arranged vertically with respect to the ground, and formed on one side in the longitudinal direction. Moreover, the driving part 440 is installed at the top of the guide part 420 and includes a screw 442 that is rotated and vertically moved by a nut unit 441 to be guided in lifting direction. The screw 442 is operated by receiving power through a motor (not shown). Additionally, a pinion transfer part 443 is disposed at an end of the screw 442 and is vertically moved by the rotation of the screw 442. The pinion transfer part 443 has a ‘C’-shaped end, to which a pinion gear 444 can be connected. Moreover, the pinion gear 444 is installed on one side of the transfer module mounting frame 410 and is engaged with a downward rack 445 provided in the movement direction of the pinion transfer part 443. Furthermore, the guide part 420 is disposed to correspond in the movement direction of the pinion transfer part 443, while being spaced apart from the pinion gear 444. Additionally, an upper rack 446 is provided between the guide part 420 and the pinion gear 444. The pinion gear 444 and the upper rack 446 are engaged with each other, and the guide part 420 and the upper rack 446 are slidably in contact with each other. In addition, the hanger part 430 is connected to an end of the upper rack 446. In this instance, the downward rack 445 is fixed, and the pinion gear 444 moves up and down by the pinion transfer part 443 and rotates while being engaged with the downward rack 445. As the pinion gear 444 moves, the upper rack 446 moves together. As a result, the upper rack 446 is guided by the guide part 420 in the movement direction and enables the hanger part 430 connected to the end thereof to move upward or downward.

Hereinafter, an automatic fryer basket supplying device according to a fourth embodiment of the the present invention will be described. In this embodiment, the difference from the first embodiment lies in that a driving part of a supply unit is implemented in the form of a timing belt actuator. The description of components overlapping with the first embodiment will be incorporated by reference to the description of the first embodiment.

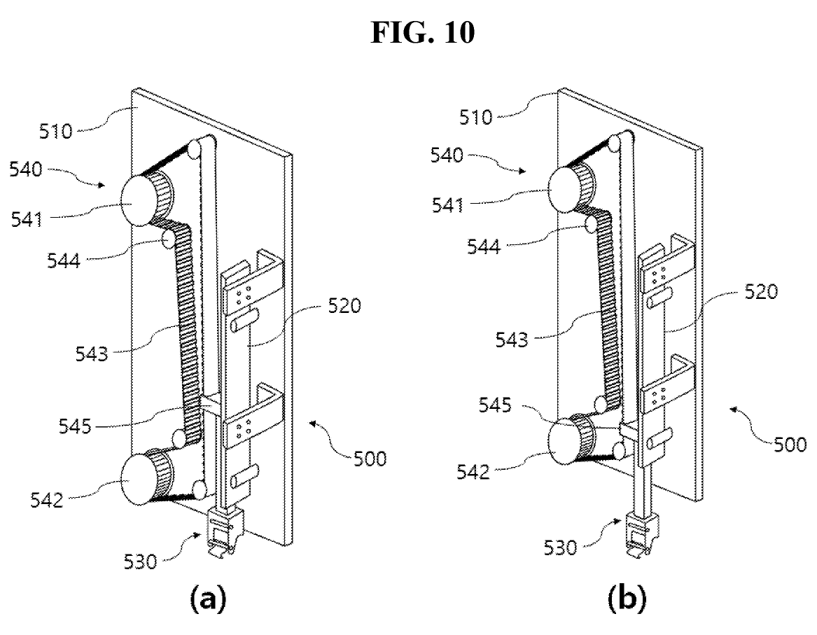

Referring to FIG. 10, a vertical transfer module 500 according to the present invention includes a transfer module mounting frame 510, a guide part 520, a hanger part 530, and a driving part 540. The guide part 520 includes a rail which is provided in a linear form, installed on one side of the transfer module mounting frame 510, arranged vertically with respect to the ground, and formed on one side in the longitudinal direction. In this instance, the surface of the guide part 520 on which the rail is formed is arranged perpendicularly to the surface of the transfer module mounting frame 510. Moreover, the driving part 540 includes: an output pulley 541 configured to rotate in forward and reverse directions by a motor (not shown) and connected to the upper side of the transfer module mounting frame 510; a timing pulley 542 connected to the lower side of the transfer module mounting frame 510; a belt member 543 engaged with the outer circumferences of the output pulley 541 and the timing pulley 542 and wrapping the output pulley 541 and the timing pulley 542; a plurality of tensioners 544 maintaining tension of the belt member 543 that rotates in forward and reverse directions by the output pulley 541 and the timing pulley 542; and a belt transfer part 545 connected to one side of the belt member 543 and configured to move together with the belt member 543 during operation. In this instance, the belt transfer part 545 is connected to the guide part 520 and is guided in the movement direction along the guide part 520. In addition, the belt transfer part 545 is also connected to the hanger part 530 such that the hanger part 530 moves upward or downward according to the operation of the belt member 543.

The embodiments described above are to be understood as illustrative and not restrictive in all respects. It should be understood that the scope of the present invention is defined by the claims set forth below rather than the foregoing detailed description, and all modifications or variations derived from the meaning and scope of the claims and their equivalents should be construed as being included within the scope of the present invention.

1. An automatic fryer basket supplying device comprising:
a supply unit installed at one side of a frying pot to enable a fryer basket to be loaded into or unloaded from frying oil; and
a control unit configured to control an operation of the supply unit,
wherein the supply unit comprises:
a support frame part fastened at one side of the frying pot to be vertical to the ground and configured to be length-adjustable in a vertical direction; and
a vertical transfer module fastened to an upper portion of the support frame part and operated under control of the control unit to elevate or lower the fryer basket, and
wherein a plurality of the supply units are selectively installed according to the capacity of the frying pot, and the plurality of supply units are individually controlled by the control unit.

2. The automatic fryer basket supplying device according to claim 1, wherein the control unit controls the supply unit such that the fryer basket is loaded into the frying oil for a first time to perform preliminary frying of food to be fried and shaken vertically, loaded again into the frying oil for a second time to perform refrying of the preliminarily fried food, and then unloaded from the frying oil and shaken again in the vertical direction.

3. The automatic fryer basket supplying device according to claim 1, wherein the vertical transfer module comprises:
a transfer module mounting frame in the form of a flat plate fastened to the upper portion of the support frame part;
a guide part joined to one surface of the transfer module mounting frame and arranged vertically with respect to the ground;
a hanger part connected to the guide part and movable in the vertical direction; and
a driving part installed at one side of the transfer module mounting frame to provide driving force for elevating and lowering the hanger part.

4. The automatic fryer basket supplying device according to claim 3, wherein the hanger part comprises:
a hanger frame formed in a rectangular cuboid shape with an open front;
hanger rods respectively fixed to both sides of the inner wall of the hanger frame and having a rod shape to which the fryer basket is hook-fastened; and
a plate spring extending downward from the bottom surface of the hanger frame and inclined toward the fryer basket to support one side of the fryer basket.

5. The automatic fryer basket supplying device according to claim 4, wherein the hanger rods comprise a first hanger rod and a second hanger rod spaced below the first hanger rod,
wherein the fryer basket comprises:
a first hook portion provided on the top of the fryer basket and hooked to the first hanger rod; and
a second hook portion provided below the first hook portion, hooked to the second hanger rod, and having a larger radius of curvature than the first hook portion,
wherein because the second hook portion has a larger radius of curvature than the first hook portion, a clearance is created around a contact area between the second hook portion and the second hanger rod, and the fryer basket is rotatable and shakable around the first hanger rod by the extent of the clearance, and
wherein the second hook part is formed to have a larger curvature radius than the first hook part such that a gap is formed around a contact portion with the second hanger rod, and the fryer basket is rotatable and shakable around the first hanger rod by the extent of the gap.
